(19) United States
(12) Patent Application Publication
(10) Pub. No.: US 2004/0091127 A1
(43) Pub. Date: May 13, 2004

(54) Small-sized vibrating motor

(76) Inventors: Hisafumi Yasuda, Tokyo (JP); Yoshiharu Wakatsuki, Tokyo (JP)

Correspondence Address: NIXON PEABODY, LLP, 401 9TH STREET, NW, SUITE 900, WASINGTON, DC, 20004-2128, US

(21) Appl. No.: 10/257,542

(22) PCT Filed: Feb. 12, 2002
(86) PCT No.: PCT/JP02/01161

(30) Foreign Application Priority Data
Feb. 15, 2001 (JP) 2001-38008

(51) Int. Cl. H04R 25/00

(52) U.S. Cl. 381/162; 381/152

(57) ABSTRACT

This invention has a cup-shaped external case 15 with a rising tube 15b in the center of the closed face 15c, the external case 15 accommodating the stator and rotor and the end of the shaft 1 opposite that where the brush seat 10 is assembled, such that by fitting the end of the shaft 1 into the rising tube from the inside of the external case 15, the external case 15 is held in a position parallel to the shaft 1, and such that by fitting the brush seat 10 into the open end of the external case 15, the external case 15 is held in place by the shaft 1 and the brush seat 10.

### FIELD OF INDUSTRIAL

This invention concerns improvement of a small, vibrating motor used in pagers, mobile telephones or other communications equipment as an alarm mechanism that rings by means of vibration.

### PRIOR TECHNOLOGY

Small, vibrating motors of this sort generally have at their center a shaft that serves as a base for assembly. The stator is assembled of field magnets fixed around the center line of the shaft, and the rotor is assembled of an excitation coil that accommodates within its diameter the field magnets separated by a magnetic gap; a magnetic yoke with the excitation coil attached within its inner periphery; and bearings that support at both ends, in a way that it is free to rotate, both ends of the yoke, which includes an eccentric weight. The semi-cylindrical eccentric weight is attached to the outer periphery of the yoke.

In this small, vibrating motor, the rotor, which is the rotating body, is located on the outside, and so it is best to enclose the entire motor, including the stator and the rotor, in an external case that is suited to surface mounting by a pick-up means such as a chuck or suction nozzle. However, when the rotor and eccentric weight are located on the outside, it is necessary to assemble the motor keeping the case parallel to the shaft, which is the base for assembly, to prevent the eccentric weight from rubbing against the inner surface of the case.

In the past, mounting in the external case has been done by assembling the brushes and bearings on the center line of the shaft, from both ends, with the field magnets in between, and so the cylindrical external case would accommodate the entire motor, including the stator and rotor, and by fitting the brush seat and bearings into the open ends of the case, the external case is hung between the brush seat and bearings (as in JPO Kokai Patent H9-37510 of 1998, for example).

In the process of mounting this external case, such things as the external shape and precision of fitting of the brushes and bearings that are fitted into the open end of the external case have an effect on the parallel relationship between the external case and the shaft that serves as a base for assembly, and so it is necessary to control them closely. In addition to keeping the external case parallel, it is necessary that it be fixed firmly to avoid any shakiness or misalignment when the motor is operated.

In addition, the rotor that is the rotating body must also be assembled parallel to the shaft, which is the base for assembly, and so that much more time and labor is required for assembly of the external case and the motor as a whole.

This invention is focused on the process of mounting the external case, and has the purpose of providing a small, vibrating motor that can be easily assembled by accurate parallel movement of the external case relative to the shaft, which is the base for assembly.

Together with that, this invention has the purpose of providing a small, vibrating motor that can be assembled by moving the external case in parallel and firmly fixing the external case so that there is no shakiness or misalignment when the motor is operated.

Also, this invention has the purpose of providing a small, vibrating motor that can be easily mounted on the circuit board of the main equipment.

In addition, this invention has the purpose of providing a small, vibrating motor that can be easily assembled by moving accurately in parallel with the shaft, which is the base for assembly.

Further, this invention has the purpose of providing a small, vibrating motor that can be assembled with the excitation coil and the magnetic yoke reliably combined as one piece.

The purposes stated above are based on technical items, and other purposes will become clear on the basis of the mode of implementation of this invention as described below.

### PRESENTATION OF INVENTION

In the vibrating motor of this invention, the shaft that is the base for assembly is at the center, and the stator comprises field magnets fixed around the center line. The rotor is made up of an excitation coil that accommodates within its diameter the field magnets, separated by a magnetic gap; a magnetic yoke within which the excitation coil is fixed; an eccentric weight mounted on the outer periphery of the magnetic yoke; and bearings that support, so that it is free to rotate, the yoke, which includes the eccentric weight, fitted around the center line from both ends, with the field magnets in between. The bearings at one end have a commutator that connects electrically to the excitation coil of the rotor, and brushes that make sliding contact with the commutator are mounted in a brush seat that is assembled with the bearing at one end of the shaft. There is a cup-shaped external case that is open at one end and closed at the other end, with a rising tube in the center of the closed end; the external case accommodates the stator and rotor and the end of the shaft opposite that where the brush seat is assembled. That end of the shaft is fitted into the rising tube from the inside of the external case, thus holding the external case in a position parallel to the shaft, and the brush seat that is assembled on the shaft at the open end of the external case is fitted into the open end of the external case, such that the case is held in place by the shaft and the brush seat.

Further, in the small vibrating motor of this invention, there is an external case that has stop claws cut and curved inward at the open end, so that the stop claws, by engaging the outer surface of the brush seat that is fitted into the open end, can fix the external shell firmly to the brush seat.

Further, brushes that connect electrically with external terminals are set in the brush seat, and the external case is flat where it faces the surface of the circuit board where the power feed lands, to which the external terminals are connected electrically, are located.

Further, there is a magnetic yoke having a sunken concavity with a through hole opened in the inward surface formed curving inward from one end, and the bearing on one end is fitted through the through hole of the sunken cavity and fastened to the magnetic yoke as a single piece. That bearing is fitted on the shaft around its center line, and so the magnetic yoke is mounted in a position that is set in parallel with the shaft.

Further, there is a magnetic yoke having a sunken concavity with a through hole opened in the inward surface formed curving inward from one end, and the bearing on one end is fitted through the through hole of the sunken cavity and molded as a single piece with the magnetic yoke. That bearing is fitted on the shaft around its center line, and so the magnetic yoke is mounted in a position that is set in parallel with the shaft.

Further, there is a magnetic yoke having a sunken concavity formed curving inward from one end, separated from the inner periphery by a fixed gap, with one end of the excitation coil fitted into that gap and the excitation coil fixed to the inner surface and assembled as a single piece with the magnetic yoke.

### BRIEF EXPLANATION OF DRAWINGS

FIG. 1 is a side section showing the small, vibrating motor of one mode of implementation of this invention.

FIG. 2 is an explanatory drawing showing the attachment of the external terminals of that motor.

FIG. 3 is a side section showing the external case of that motor.

FIG. 4 is a left end view showing that motor.

FIG. 5 is a right end view showing that motor.

FIG. 6 is a partial side section showing the bearing at one end of that motor.

FIG. 7 is a partial side section showing the bearing at the other end of that motor.

FIG. 8 is an explanatory drawing showing the external terminals of that motor mounted to connect electrically with the power feed lands of the circuit board.

### OPTIMUM MODE OF IMPLEMENTATION

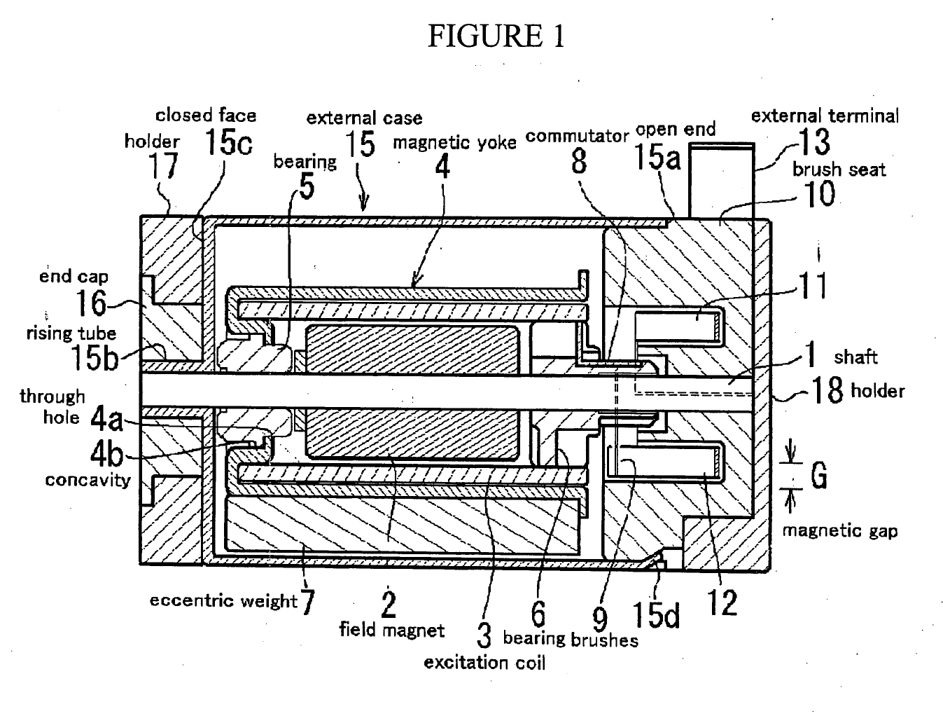

The explanation below refers to the mode of implementation shown in the drawings. The mode of implementation shown in the drawings is an example of a small, vibrating motor used in pagers, mobile telephones or other communications equipment as an alarm mechanism that rings by means of vibration. This small, vibrating motor is assembled with a shaft 1 at its center, and a stator and a rotor assembled with the shaft 1 as an assembly base, as shown in FIG. 1.

In this small, vibrating motor, the stator has the shaft 1 as a fixed axis, with a cylindrical field magnet 2 mounted on the center line of the shaft 1, which passes through a central hole in the field magnet 2.

The rotor comprises a cylindrical excitation coil 3 that accommodates the field magnet 2 within its diameter and which is separated from the field magnet 2 by a magnetic gap G, a cylindrical magnetic yoke 4 that has the excitation coil 3 fixed within it by an adhesive (unlabeled), and bearings 5, 6 that are fitted around the center line at both ends of the shaft 1, with the field magnet 2 between them. A semi-cylindrical eccentric weight 7 is attached to the outer periphery of the magnetic yoke 4, and the magnetic yoke 4 including the eccentric weight 7 is supported such that it is free to rotate.

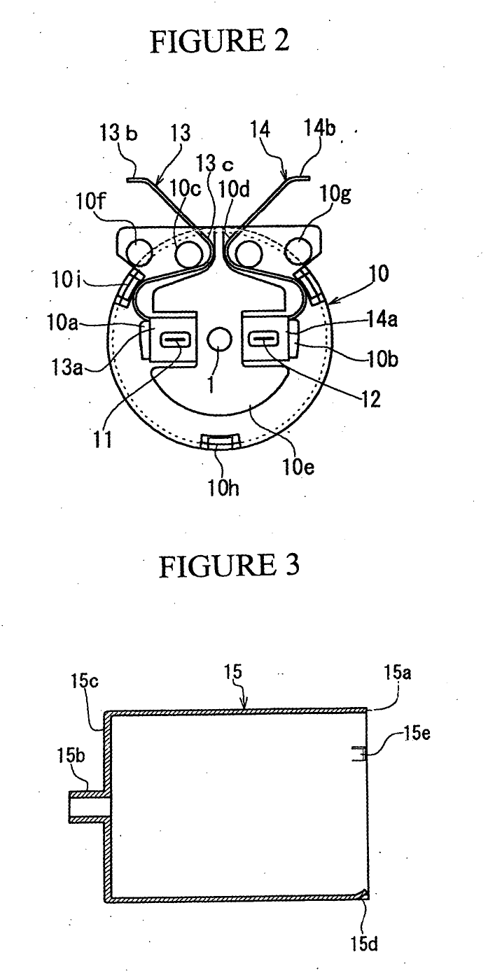

The electrical circuit includes the commutator 8 that is connected electrically to the excitation coil 3 and mounted on the bearing at one end, and the brushes 9 that slide against the commutator 8 are set in a brush seat 10 that is assembled at one end of the shaft 1. The brush seat 10 also serves as a terminal seat; it is assembled so that conductive plates 11, 12 that hold the brushes 9 are inserted through to its interior, and external terminals 13, 14, as shown in FIG. 2, are connected electrically to extensions of the conductive plates 11, 12.

The external terminals 13, 14 are a symmetrical pair of leaf springs bent in an S-shape, extending up from the attachment bases 13a, 14a to spring terminals 13b, 14b. The external terminals 13, 14 have attachment bases 13a, 14a that are bent into a squared U-shape and that are fitted and fixed to projections 10a, 10b on the brush seat 10, and they have upper curves 13c, 14c that are located where they can be stopped and supported by stop pins 10c, 10d of the brush seat 10; the two are separated by a center bar 10e on the brush seat 10. The spring terminals 13b, 14b extend outward at a slant, and are rounded outward at their upper ends.

With the constitution described above as the basic mode, this small, vibrating motor is assembled with the stator and rotor accommodated inside the external case 15. The external case 15, as shown in FIG. 3, is cup-shaped, being open at one end 15a while the other end is closed, with a small-diameter cylindrical rising tube 15b located in the center of the closed face 15c.

With one end of the shaft 1 fitted inside the rising tube 15b, the external case 15 accommodates the brush seat 10 that is assembled on the other end of the shaft 1, and also the stator and rotor. By assembling the brush seat 10 on the end of the shaft 1 and fitting it into the open end 15a, it is possible to have the shaft 1 and the brush seat 10 held firmly together.

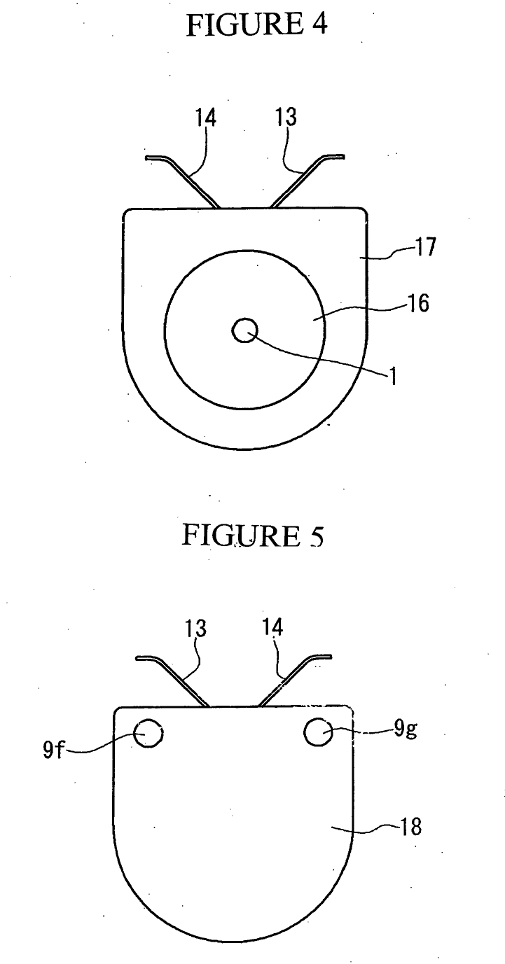

In addition to the constituent parts described above, there is an end cap 16 that is fitted and fixed to the outside of the rising tube 15 at one end of the external case 15, as shown in FIGS. 1 and 4. By pushing the end cap 16 into place, a holder 17 made of a flexible material such as rubber or resin is fastened to the closed face 15c of the external case 15. And as shown in FIG. 5, a holder 18 made of a flexible material such as rubber or resin is fastened to the brush seat 10 by means of columnar stop pins 10f, 10g (see FIG. 2).

In the small, vibrating motor constituted in this way, the rising tube 15b of the external case is held lengthwise to the center line of the shaft 1. By this means, the external case 15 can be accurately positioned parallel to the shaft 1 which is the assembly base, and so assembly can be accomplished easily without the eccentric weight 7 scraping the inner surface of the external case 15.

In the constitution described above, the external case 15 has approximately three stop claws 15d, 15e . . . cut and curved inward at the open end 15a (see FIG. 3), spaced at even intervals; the open end 15a of the external case 15 can be fitted and fixed to the brush seat 10 by engaging these stop claws 15d, 15e . . . with the outer surface of the brush seat 10. By this means, the external case 15 will be kept parallel, and will be fastened securely so that no shakiness or misalignment will accompany the vibration. Now, it is also possible to have receiving grooves 10h, 10i . . . on the outer surface of the brush seat 10 (see FIG. 2) to match the stop claws 15d, 15e . . .

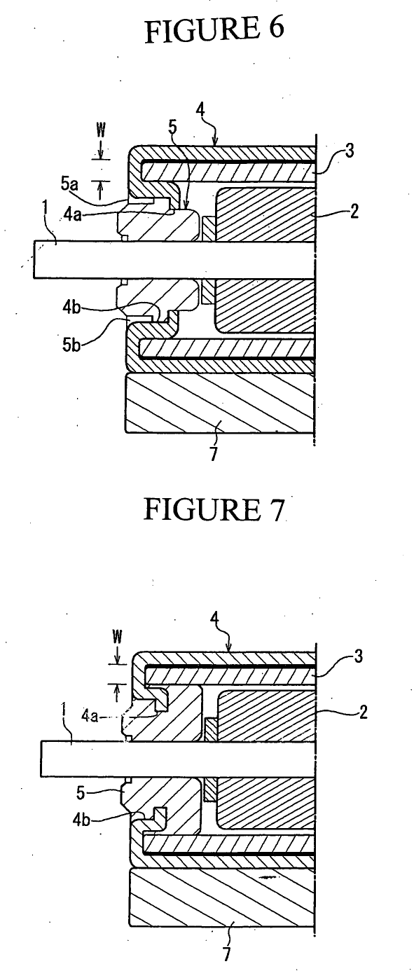

The magnetic yoke has a sunken concavity 4b with a through hole 4a opened in the inward surface formed curving inward from one end, and the bearing 5 on one end is fitted through the through hole 4a of the sunken cavity 4b and fastened to the magnetic yoke 4 as a single piece, as shown in FIG. 6. The bearing 5 can have cutout grooves 5a, 5b at regular intervals around the circumference that are filled with an adhesive to unite it securely to the magnetic yoke 4. In this magnetic yoke 4, the bearing 5 is fitted around the centerline of the shaft 1, and so it is easily assembled by mounting it in a position parallel to the shaft 1.

Instead of fitting and fixing the bearing in that way, it is possible to assemble the bearing 5 as a single piece with the magnetic yoke 4 by molding it through the through hole 4a from the sunken cavity 4b, as shown in FIG. 7. The sunken cavity 4b is formed curving inward with a given space W separating it from the inner surface of the magnetic yoke 4, and the excitation coil 3 is assembled more securely by coating the inner surface of the magnetic yoke 4 with an adhesive and fitting one end of the excitation coil 3 into the space W.

This small, vibrating motor is assembled with an external case 15 that accommodates the motor, stator, rotor and all, and so by holding the external case 15 with a chuck, suction nozzle or similar device, it can be assembled into the larger equipment by means of surface mounting, the same as other assembly parts.

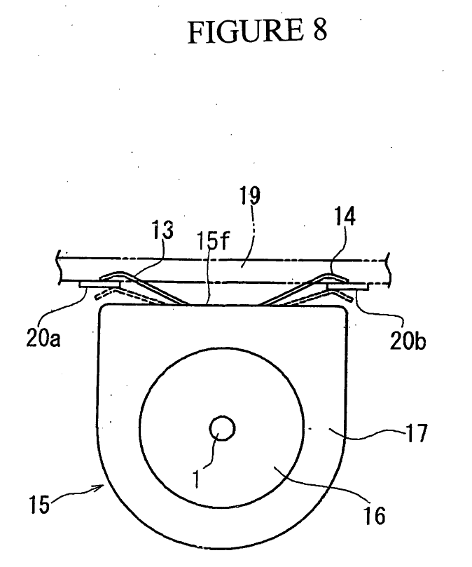

When mounting this small, vibrating motor, it can be mounted with the external terminals 13, 14 pressing against the power feed lands 20a, 20b of the circuit board 19, as shown in FIG. 8, so that they connect electrically with the power feed lands 20a, 20b by means of deformation under pressure. If this small, vibrating motor is assembled with an external case 15 that has a flat surface 15f on the side facing the circuit board 19, a damper (not illustrated) of flexible material can be sandwiched between the flat surface 15f and the circuit board 19 to provide shock absorption.

The terms and expressions used in the specification of this invention are used simply for the purpose of explanation, and do not limit the content of the invention in any way. The use of any limiting terms or expressions is not intended to exclude thereby any equivalent mode of implementation or part thereof. It is clear, therefore, that it is possible to make various changes within the scope of the invention for which rights are claimed.

### Potential for Industrial Use

Using the small, vibrating motor of this invention, there is a cup-shaped external case that is open at one end and closed at the other end, with a rising tube in the center of the closed face, which accommodates within it the stator and rotor on the shaft on which the brush seat is mounted, the end of the shaft fitting inside the rising tube from inside the external case so that the external case is positioned parallel to the shaft, and so that the brush seat mounted on the end of the shaft at the open end of the external case is fitted into the open end to hold the external case firmly to the shaft and brush seat, by which means the external case can be accurately positioned parallel to the shaft that serves as the base for assembly, so that the motor can be assembled easily and accurately while avoiding scraping between the eccentric weight and the inner surface of the external case.

Further, in the small vibrating motor of this invention, there is an external case that has stop claws cut and curved inward at the open end, so that the stop claws, by engaging the outer surface of the brush seat that is fitted into the open end, can fix the external shell firmly to the brush seat.

Further, brushes that connect electrically with external terminals are set in the brush seat, and the external case is flat where it faces the surface of the circuit board where the power feed lands, to which the external terminals are connected electrically, are located, so that a damper of flexible material can be sandwiched between the flat surface and the circuit board to provide shock absorption.

Further, there is a magnetic yoke having a sunken concavity with a through hole opened in the inward surface formed curving inward from one end, and the bearing on one end is fitted through the through hole of the sunken cavity and fastened to the magnetic yoke as a single piece. That bearing is fitted on the shaft around its center line, and so the magnetic yoke can be mounted in a position that is set in parallel with the shaft, and easily assembled.

Further, there is a magnetic yoke having a sunken concavity with a through hole opened in the inward surface formed curving inward from one end, and the bearing on one end is fitted through the through hole of the sunken cavity and molded as a single piece with the magnetic yoke. That bearing is fitted on the shaft around its center line, and so the magnetic yoke can be mounted in a position that is positioned in parallel with the shaft, and easily assembled.

Further, there is a magnetic yoke having a sunken concavity formed curving inward from one end, separated from the inner periphery by a fixed gap, with one end of the excitation coil fitted into that gap and the excitation coil fixed to the inner surface and assembled as a single piece with the magnetic yoke.

1. A small, vibrating motor having a shaft that is the base for assembly at the center, and the stator comprises field magnets fixed around the center line; a rotor made up of an excitation coil that accommodates within its diameter the field magnets, separated by a magnetic gap, a magnetic yoke within which the excitation coil is fixed, an eccentric weight mounted on the outer periphery of the magnetic yoke, bearings that support, so that it is free to rotate, the yoke, which includes the eccentric weight, fitted around the center line from both ends, and the field magnets in between, the bearing at one end having a commutator that connects electrically to the excitation coil of the rotor, and brushes that make sliding contact with the commutator and that are mounted in a brush seat that is assembled with the bearing at one end of the shaft,
in which there is a cup-shaped external case that is open at one end and closed at the other end, with a rising tube in the center of the closed end; the external case accommodating the stator and rotor and the end of the shaft opposite that where the brush seat is assembled, such that the end of the shaft is fitted into the rising tube from the inside of the external case, thus holding the external case in a position parallel to the shaft, and the brush seat that is assembled on the shaft at the open end of the external case is fitted into the open end of the external case, with the result that the external case is held in place by the shaft and the brush seat.

2. A small, vibrating motor as described in claim 1 above, in which there is an external case that has stop claws cut and curved inward at the open end, so that the stop claws, by engaging the outer surface of the brush seat that is fitted into the open end, can fix the external shell firmly to the brush seat.

3. A small, vibrating motor as described in claims 1 or 2 above, in which brushes that connect electrically with external terminals are set in the brush seat, and there is an external case that is flat where it faces the surface of the circuit board where the power feed lands, to which the external terminals are connected electrically, are located.

4. A small, vibrating motor as described in claims 1 through 3 above, in which there is a magnetic yoke having a sunken concavity with a through hole opened in the inward surface formed curving inward from one end, and the bearing on one end is fitted through the through hole of the sunken cavity and fastened to the magnetic yoke as a single piece, with the bearing fitted on the shaft around its center line, so that the magnetic yoke is mounted in a position parallel to the shaft.

5. A small, vibrating motor as described in claims 1 through 3 above, in which there is a magnetic yoke having a sunken concavity with a through hole opened in the inward surface formed curving inward from one end, and the bearing on one end is fitted through the through hole of the sunken cavity and molded as a single piece with the magnetic yoke, the bearing being fitted on the shaft around its center line, so that the magnetic yoke is mounted in a position that is positioned parallel to the shaft.

6. A small, vibrating motor as described in claim 4 or 5 above, in which there is a magnetic yoke having a sunken concavity formed curving inward from one end, with one end of the excitation coil fitted into a gap and the excitation coil fixed to the inner surface and assembled as a single piece with the magnetic yoke.
